(19) United States
(12) Patent Application Publication
(10) Pub. No.: US 2017/0218852 A1
(43) Pub. Date: Aug. 3, 2017

(54) INLET BLEED HEAT SYSTEM AND METHOD OF ASSEMBLING THE SAME

(71) Applicant: General Electric Company, Schenectady, NY (US)

(72) Inventors: Joseph Philip Klosinski, Kennesaw, GA (US); Alston Ilford Scipio, Mableton, GA (US); Alex Clinton Solomon, San Francisco, CA (US); Sanji Ekanayake, Mableton, GA (US); Hannah Louise Dombek, Atlanta, GA (US)

(21) Appl. No.: 15/012,473

(22) Filed: Feb. 1, 2016

(51) Int. Cl. F02C 9/18; F02C 7/047

(52) U.S. Cl. CPC F02C 9/18; F02C 7/047; F05D 2220/32; F05D 2260/232

(57) ABSTRACT

An inlet bleed heat system for use with a turbine assembly includes a first discharge line coupled in flow communication between a compressor and an intake manifold assembly. A first control valve that is coupled to the first discharge line and operable to control a first discharge flow through the first discharge line from the compressor to the intake manifold assembly during a first operational mode. A second discharge line that is coupled in flow communication between the compressor and the intake manifold assembly and a second control valve that is coupled to the second discharge line and operable to control a second discharge flow through the second discharge line from the compressor to the intake manifold assembly during a second operational mode.

### BACKGROUND

The present disclosure relates generally to turbine engines and, more specifically, to inlet bleed heat systems and methods of assembling the same.

Generally turbine assemblies include a compressor, a combustor, and a turbine coupled in a serial flow relationship. The compressor compresses air from an air intake, and subsequently directs the compressed air to the combustor. Compressed air received from the compressor is mixed with a fuel and is combusted to create combustion gases. The combustion gases are directed into the turbine. In the turbine, the combustion gases pass across turbine blades of the turbine, thereby driving the turbine blades, and a shaft to which the turbine blades are attached, into rotation. The rotation of the shaft may further drive a load, such as an electrical generator, coupled to the shaft.

At least some known turbine assemblies are susceptible to surge within the assembly, which may reduce the performance and reliability of the turbine assembly. Surge may occur when flow separates from compressor blades causing flow reversal within the compressor. Surge may be reduced by extracting, or bleeding, compressed air from the compressor when the pressure of the compressed air exceeds an operational limit of the turbine assembly. Additionally, at least some known turbine assemblies may be susceptible to icing within the assembly during low temperature operations. Icing may reduce the performance and reliability of the turbine assembly. Therefore, in some turbine assemblies, a portion of compressed air is extracted from the compressor and is channeled to the air intake, thus raising the temperature of the intake air to reduce icing. However extracting too much compressed air may reduce the overall performance of the turbine assembly.

### BRIEF DESCRIPTION

In one aspect, an inlet bleed heat system for use with a turbine assembly is provided. The system includes a first discharge line that is coupled in flow communication between a compressor and an intake manifold assembly. A first control valve that is coupled to the first discharge line and operable to control a first discharge flow through the first discharge line from the compressor to the intake manifold assembly during a first operational mode. A second discharge line that is coupled in flow communication between the compressor and the intake manifold assembly and a second control valve that is coupled to the second discharge line and operable to control a second discharge flow through the second discharge line from the compressor to the intake manifold assembly during a second operational mode.

In a further aspect, a turbine engine assembly is provided. The turbine assembly includes an intake manifold assembly, a compressor coupled in flow communication and downstream from the intake manifold assembly, a turbine coupled in flow communication and downstream from the compressor, and an inlet bleed heat system. The inlet bleed heat system includes a first discharge line coupled in flow communication between a compressor and an intake manifold assembly. A first control valve that is coupled to the first discharge line and operable to control a first discharge flow through the first discharge line from the compressor to the intake manifold assembly during a first operational mode. A second discharge line that is coupled in flow communication between the compressor and the intake manifold assembly and a second control valve that is coupled to the second discharge line and operable to control a second discharge flow through the second discharge line from the compressor to the intake manifold assembly during a second operational mode.

In another aspect, a method of assembling an inlet bleed heat system for a turbine assembly is provided. The method includes coupling a first discharge line in flow communication between a compressor and an intake manifold assembly. Coupling a first control valve to the first discharge line, the first control valve is operable to control a first discharge flow through the first discharge line from the compressor to the intake manifold assembly during a first operating condition. Coupling a second discharge line in flow communication between the compressor and the intake manifold assembly and coupling a second control valve to the second discharge line, the second control valve is operable to control a second discharge flow through the second discharge line from the compressor to the intake manifold assembly during a second operating condition.

### BRIEF DESCRIPTION OF THE DRAWINGS

FIG. 1 is a schematic view of an exemplary turbine assembly including an exemplary inlet bleed heat system;

FIG. 2 is a schematic view of a turbine assembly including another embodiment of an inlet bleed heat system;

FIG. 3 is a schematic view of a turbine assembly including a further embodiment of an inlet bleed heat system;

FIG. 4 is a schematic view of a turbine assembly including yet another embodiment of an inlet bleed heat system; and

FIG. 5 is a flow diagram of an exemplary method of assembling an inlet bleed heat system, such as the inlet bleed heat system shown in any of FIGS. 1-4.

### DETAILED DESCRIPTION OF THE INVENTION

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Approximating language may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be identified. Such ranges may be combined and/or interchanged, and include all the sub-ranges contained therein unless context or language indicates otherwise.

Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

The exemplary inlet bleed heat systems and methods described herein overcome at least some of the disadvantages associated with known systems and methods for surge and ice protection within a turbine assembly. The embodiments herein include at least a pair of discharge lines coupled in flow communication between, and extending from, a compressor to an inlet bleed heat manifold. Each discharge line includes a control valve that opens in response to a controller that implements at least one of an operational limit line control and an anti-icing control, thereby increasing control of the required inlet bleed heat flow rate to facilitate reducing turbine output and heat rate losses. In certain embodiments, the turbine assembly includes an ejector that draws in at least either filtered ambient air and/or turbine exhaust gases such that flow distributions within the inlet bleed heat manifold are maintained and/or bleed heat temperature is increased. Moreover, in some embodiments, the turbine assembly includes a second inlet bleed heat manifold coupled to one of the discharge lines that is sized to match the flow rate of the second valve to facilitate an even flow distribution. In each embodiment, the inlet bleed heat systems and methods facilitate reducing excess compressor bleeding not required for operational limit line control and/or anti-icing control.

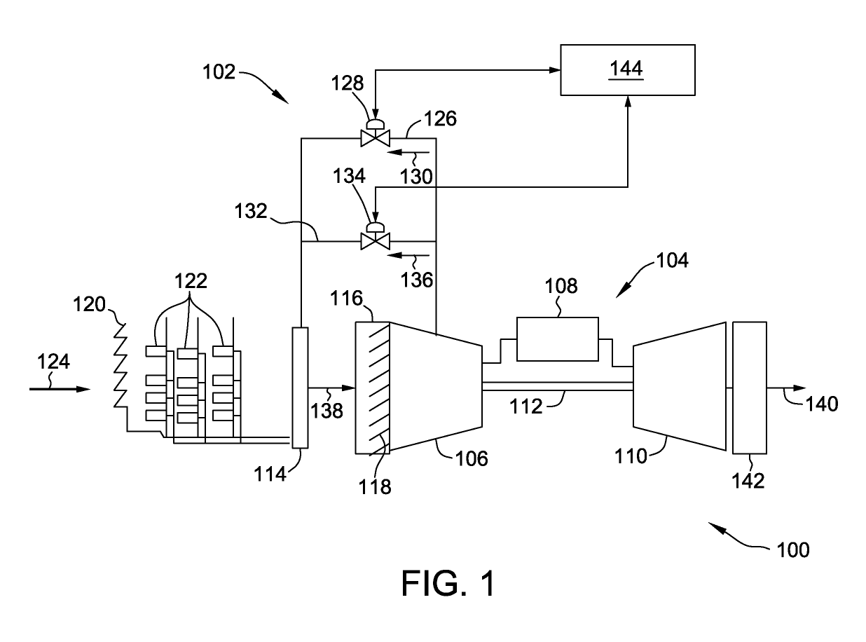

FIG. 1 is a schematic view of an exemplary embodiment of a turbine assembly 100 having an inlet bleed heat system 102. In the exemplary embodiment, turbine assembly 100 includes at least one turbine engine 104. Each turbine engine 104 includes a compressor assembly 106. A combustor assembly 108 is downstream from, and in flow communication with, compressor assembly 106, and a turbine assembly 110 is coupled downstream from, and in flow communication with, combustor assembly 108. Turbine assembly 110 is coupled to compressor assembly 106 via a rotor assembly 112.

Additionally, in the exemplary embodiment, turbine assembly 100 includes an inlet bleed heat intake manifold assembly 114 coupled in flow communication with and upstream from, a compressor inlet 116 having articulated inlet guide vanes 118. Additionally, an inlet screen or filter house 120 is upstream from inlet bleed heat manifold assembly 114. Inlet screen 120 includes a plurality of inlet air filters 122 that remove moisture and particulate matter, such as dust and/or debris, from an ambient air flow 124 entering turbine assembly 100.

The exemplary inlet bleed heat system 102 includes a first discharge line 126 coupled in flow communication between, and extending from, compressor assembly 106 to intake manifold assembly 114. A first control valve 128 is coupled to first discharge line 126 and is operable to control a first discharge flow 130 through first discharge line 126 from compressor assembly 106 to intake manifold assembly 114. Additionally, inlet bleed heat system 102 includes a second discharge line 132 coupled in flow communication between, and extending from, compressor assembly 106 to intake manifold assembly 114. A second control valve 134 is coupled to second discharge line 132 and is operable to control a second discharge flow 136 through second discharge line 132 from compressor assembly 106 to intake manifold assembly 114. In the exemplary embodiment, first control valve 128 is a variable flow rate valve that has a predetermined minimum flow rate therethrough. Additionally, second control valve 134 is an adjustable flow rate valve. The adjustable flow rate of second control valve 134 is less than the predetermined minimum flow rate of first control valve 128. In alternative embodiments, first and second control valve 128 and 134 are each any other suitable type of valve that enables inlet bleed heat system 102 to operate as described herein.

In operation, ambient air flow 124 is channeled through inlet screen 120 upstream from inlet manifold assembly 114 such that moisture and particulate matter is at least partially removed. Additionally, ambient air flow 124 is channeled through intake manifold assembly 114, such that the air is selectively mixed and/or heated with additional air flow, such as first and second discharge flows 130 and 136, thereby forming an intake air flow 138 for turbine engine 104. Intake air flow 138 is channeled through compressor assembly 106 and is compressed to higher pressures and temperatures prior to being discharged towards combustor assembly 108. The compressed air is mixed with fuel and burned within combustor assembly 108 to generate combustion gases that are channeled downstream towards turbine assembly 110. As the combustion gases impinge turbine assembly 110, thermal energy is converted to mechanical rotational energy that is used to drive rotor assembly 112. The flow of combustion gases is discharged from turbine engine 104 as an exhaust gas flow 140 via an exhaust assembly 142.

In the exemplary embodiment, first and second control valves 128 and 134 are operatively coupled to a controller 144. Controller 144 implements at least one of an operational limit line control of compressor assembly 106 and an anti-icing control of turbine assembly 100, and controls first and second control valves 128 and 134 in response to the operational limit line control and/or the anti-icing control. For example, during operation compressor assembly 106 may be susceptible to surge, e.g., flow reversal within compressor assembly 106 caused by flow separation from compressor blades (not shown). An operational limit line is established by the manufacturer of turbine engine 104 as the operating limit for compressor assembly 106 to reduce the occurrence of surge. The operational limit line control facilitates reducing surge within compressor assembly 106 by bleeding compressed air from compressor assembly 106 when the operational limit line is reached. The bleed air may be recycled back into intake air flow 138 through inlet bleed heat system 102.

Alternatively or additionally, during operation of turbine assembly 100 in low-temperature conditions, ice may build up around compressor inlet 116, reducing fluid flow therein. Similarly, a predetermined air temperature limit is established by the manufacturer of turbine engine 104 as the air temperature below which turbine assembly 100 is at risk of icing during operation. The anti-icing control facilitates reducing ice around compressor inlet 116 by bleeding higher temperature compressed air from compressor assembly 106 when the air temperature drops below the predetermined air temperature limit. The bleed air flows through inlet bleed heat system 102 and heats intake air flow 138 to facilitate reducing ice. In the exemplary embodiment, first and second discharge lines 126 and 132 are illustrated as being coupled to a single compressor stage. However, it should be appreciated that in alternative embodiments, first and second discharge lines 126 and 132 are coupled to multiple and/or different compressor stages.

Communication between the various elements of controller 144 is depicted in FIG. 1 via arrowhead lines that illustrate either signal communication or mechanical operation, depending on the system element involved. Communication among and between the various system elements may be obtained through a hardwired or a wireless arrangement. Controller 144 may be a standalone computer or a network computer and may include instructions in a variety of computer languages for use on a variety of computer platforms and under a variety of operating systems. Other examples of controller 144 include a system having a microprocessor, microcontroller, or other equivalent processing device capable of executing commands of computer readable data or programs for executing a control algorithm. In order to perform the prescribed functions and desired processing, as well as the computations therefor, controller 144 may include, for example and without limitation, processor(s), memory, storage, register(s), timing, interrupt(s), communication interfaces, and input/output signal interfaces, as well as combinations including at least one of the foregoing.

In operation, controller 144 during a second operational mode is programmed to open second control valve 134, such that second discharge flow 136 is channeled from compressor assembly 106 to intake manifold assembly 114, in response to at least one of the operational limit line control and anti-icing control. Furthermore, controller 144 determines whether the operational limit line control and/or anti-icing control are satisfied in response to second discharge flow 136. When second discharge flow 136 is not sufficient to satisfy the operational limit line control and/or anti-icing control, controller 144 during a first operational mode is programmed to open first control valve 128, such that first discharge flow 130 is channeled from compressor assembly 106 to intake manifold assembly 114, in response to at least one of the operational limit line control and anti-icing control. In certain embodiments, controller 144 is also programmed to close second control valve 134 during and/or after opening of first control valve 128. Alternatively, controller 144 is further programmed to maintain second control valve 134 open during and/or after opening first control valve 128.

For example, in the exemplary embodiment, an operational limit line of compressor assembly 106 is stored by controller 144. When compressor assembly 106 reaches the operational limit line, controller 144, during the second operational mode and implementing the operational limit line control, opens second control valve 134 such that compressed air is extracted from compressor assembly 106 into second discharge line 132. Second discharge flow 136 is channeled through second discharge line 132 to intake manifold assembly 114, mixed with ambient air flow 124, and is then recycled back into turbine engine 104 as intake air flow 138. If second discharge flow 136 is not sufficient to drop compressor assembly 106 from the operational limit line, controller 144, during the first operational mode and further implementing the operational limit line control, opens first control valve 128 and extracts compressed air from compressor assembly 106 into first discharge line 126. First discharge flow 130 is then channeled through first discharge line 126 to intake manifold assembly 114, mixed with ambient air flow 124 and (in embodiments in which second control valve 134 remains open) second discharge flow 136, and is then recycled back into turbine engine 104 as intake air flow 138.

Furthermore, for example, in the exemplary embodiment, a predetermined air temperature limit to prevent icing of turbine assembly 100 is stored by controller 144. When a temperature of intake air flow 138 drops below the predetermined air temperature limit, controller 144, during the second operational mode and implementing the anti-icing control, opens second control valve 134 and extracts relatively higher temperature compressed air from compressor assembly 106 into second discharge line 132. Second discharge flow 136 is channeled through second discharge line 132 to intake manifold assembly 114, mixed with ambient air flow 124, and is then recycled back into turbine engine 104 as intake air flow 138. If second discharge flow 136 is not sufficient to raise the temperature of intake air flow 138 to at least the predetermined air temperature limit, controller 144, during the first operational mode and further implementing the anti-icing control, opens first control valve 128 and extracts relatively higher temperature compressed air from compressor assembly 106 into first discharge line 126. First discharge flow 130 is then channeled through first discharge line 126 to intake manifold assembly 114, mixed with ambient air flow 124 and (in embodiments in which second control valve 134 remains open) second discharge flow 136, and is then recycled back into turbine engine 104 as intake air flow 138.

As described above, the adjustable flow rate through second control valve 134 is less than the minimum flow rate through first control valve 128. Increased efficiency of operation of turbine assembly 100 is facilitated because of first and second control valves 128 and 134 having different flow rates. More specifically, bleed from compressor assembly 106, e.g., first and second discharge flows 130 and 136, is first drawn at the relatively low adjustable flow rate associated with second control valve 134, thus facilitating reducing a negative performance impact on turbine assembly 100 associated with excess bleed. The higher flow rate associated with first control valve 128 is used only after determining that second discharge flow 136 is insufficient to satisfy the control objective established by the operational limit line control and/or anti-icing control. For comparison, in a similar system but with only first control valve 128 and first discharge line 126 present, first control valve 128 is opened by controller such that at least the minimum flow rate within first control valve 128 is extracted from compressor assembly 106 in response to any trigger from the operational limit line control and/or anti-icing control. The addition of second control valve 134 and second discharge line 132 facilitates enabling inlet bleed heat system 102 to bleed from compressor assembly 106 at a flow rate that is lower than the minimum flow rate through first control valve 128 when appropriate, while maintaining the benefits of a large capacity first control valve 128 for more demanding operational limit line and/or anti-icing control scenarios.

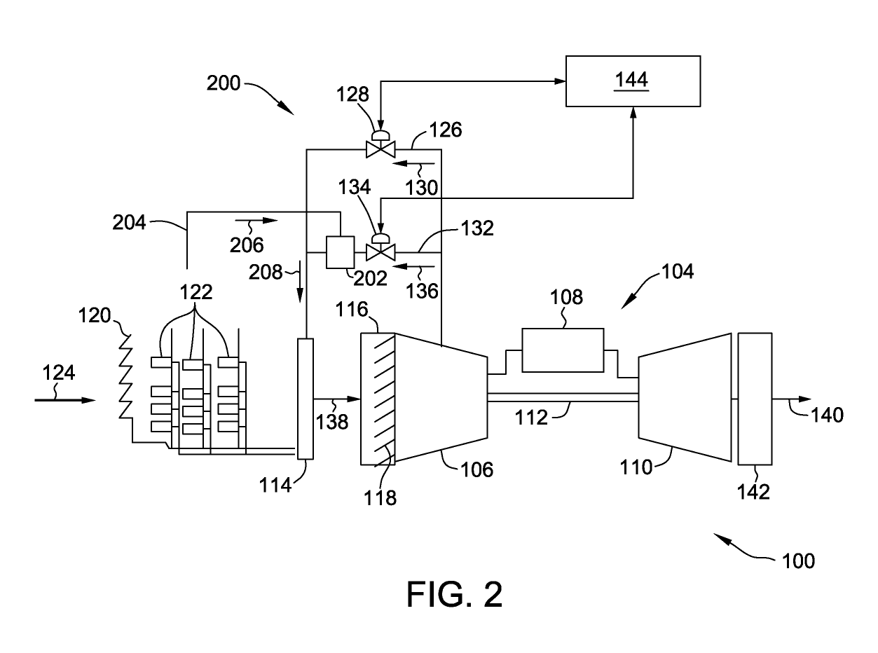

FIG. 2 is a schematic view of turbine assembly 100 including another exemplary embodiment of an inlet bleed heat system 200. Inlet bleed heat system 200 is substantially identical to the embodiment described above with reference to FIG. 1, except for as described herein. For example, in the exemplary embodiment, turbine assembly 100 includes compressor assembly 106, combustor assembly 108, turbine assembly 110, intake manifold assembly 114, and inlet bleed heat system 200. Similarly, inlet bleed heat system 200 includes first discharge line 126, first control valve 128, second discharge line 132, second control valve 134, and controller 144. However, in this embodiment, inlet bleed heat system 200 also includes an ejector 202 coupled to second discharge line 132 downstream from second control valve 134.

In the exemplary embodiment, intake manifold assembly 114 receives a predetermined minimum flow rate from inlet bleed heat system 200. Ejector 202 is coupled in flow communication to inlet air screen 120 and filters 122 via an ejector line 204. Ejector 202 draws a filtered ambient air flow 206 through ejector line 204 when second discharge flow 136 flows through ejector 202. In the exemplary embodiment, filtered ambient air flow 206 is extracted downstream from inlet air filters 122. Ejector 202 further mixes second discharge flow 136 with filtered ambient air flow 206, forming a mixture flow 208 with an increased flow rate relative to the flow rate of second discharge flow 136. Therefore, intake manifold assembly 114 receives mixture flow 208 from inlet bleed heat system 200 that is at least the predetermined minimum flow rate, thereby maintaining a design flow distribution within intake manifold assembly 114. For example, in operational limit line control, ejector 202 adds to the flow rate of second discharge flow 136 such that mixture flow 208 has at least the predetermined minimum flow rate required by intake manifold assembly 114, in addition to second discharge flow 136 facilitating reducing surge within compressor assembly 106. For another example, in anti-icing control, ejector 202 adds to the flow rate of second discharge flow 136 such that mixture flow 208 has at least the predetermined minimum flow rate required by intake manifold assembly 114, in addition to second discharge flow 136 forming mixture flow 208 as an increased-temperature mixture to facilitate reducing icing.

In operation, controller 144 is programmed to open second control valve 134, such that second discharge flow 136 is channeled from compressor assembly 106 through ejector 202 and to intake manifold assembly 114 in response to at least one of the operational limit line control and anti-icing control. Relatively high pressure second discharge flow 136 generates a suction force at ejector line 204 that draws filtered ambient air flow 206 through ejector line 204 to form mixture flow 208, such that mixture flow 208 is at least the predetermined minimum flow rate required from inlet bleed heat system 200 by intake manifold assembly 114. Furthermore, controller determines whether the operational limit line control and/or anti-icing control are satisfied in response to second discharge flow 136. When second discharge flow is not sufficient to satisfy the operational limit line control and/or anti-icing control, controller 144 is programmed to open first control valve 128, such that first discharge flow 130 is channeled from compressor assembly 106 to intake manifold assembly 114, in response to at least one of the operational limit line control and anti-icing control. In certain embodiments, controller 144 is further programmed to close second control valve 134 during and/or after opening first control valve 128. Alternatively, controller 144 is further programmed to maintain second control valve 134 open during and/or after opening first control valve 128. In the exemplary embodiment, first control valve 128 provides a minimum flow rate for first discharge flow 130 that is at least the predetermined minimum flow rate specified for intake manifold assembly 114, and thus first discharge line 126 does not flow through an ejector. Alternatively or additionally, first discharge line 126 includes an ejector that enables inlet bleed heat system 102 to operate as described herein.

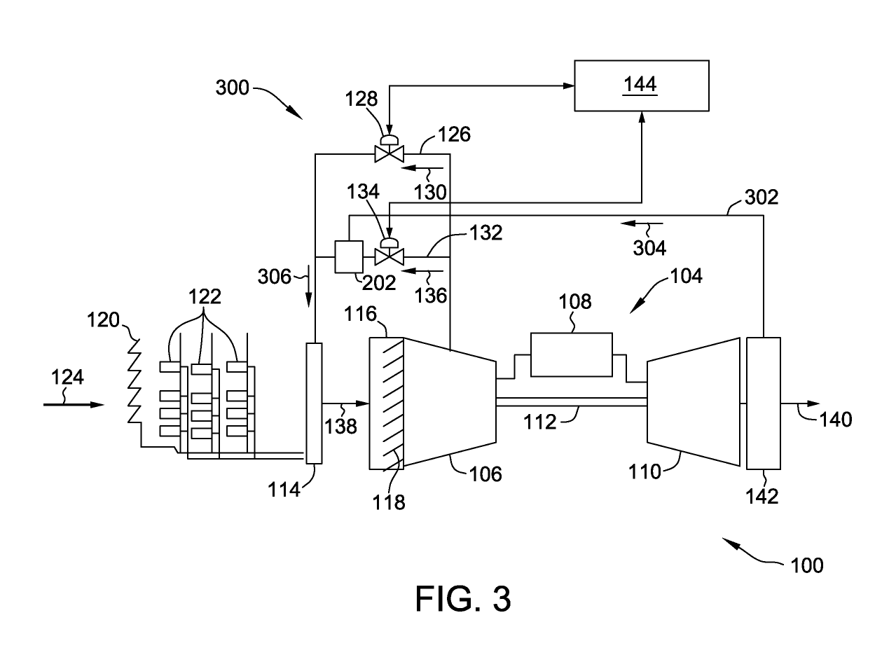

FIG. 3 is a schematic view of turbine assembly 100 including a further exemplary embodiment of an inlet bleed heat system 300. Inlet bleed heat system 300 is substantially identical to the embodiments described above with reference to FIGS. 1 and 2, except for as described herein. For example, in the exemplary embodiment, turbine assembly 100 includes compressor assembly 106, combustor assembly 108, turbine assembly 110, intake manifold assembly 114, and inlet bleed heat system 300. Similarly, inlet bleed heat system 300 includes first discharge line 126, first control valve 128, second discharge line 132, second control valve 134, controller 144, ejector 202, and intake manifold assembly 114 that receives a predetermined minimum flow rate from inlet bleed heat system 300. However, in this embodiment, ejector 202 is coupled in flow communication to exhaust assembly 142 via an ejector line 302.

In the exemplary embodiment, ejector 202 mixes second discharge flow 136 with an exhaust flow 304 channeled through ejector line 302 and extracted from exhaust gas flow 140 within exhaust assembly 142 to form mixture flow 306 with an increased flow rate relative to the flow rate of second discharge flow 136. Therefore, intake manifold assembly 114 receives mixture flow 306 from inlet bleed heat system 300 that is at least the predetermined minimum flow rate, thereby maintaining a design flow distribution within intake manifold assembly 114. For example, in operational limit line control, ejector 202 adds to the flow rate of second discharge flow 136 such that mixture flow 306 has at least the predetermined minimum flow rate specified for intake manifold assembly 114, in addition to second discharge flow 136 facilitating reducing surge within compressor assembly 106. For another example, in anti-icing control, ejector 202 adds to the flow rate of second discharge flow 136 such that mixture flow 306 has at least the predetermined minimum flow rate specified by intake manifold assembly 114, in addition to second discharge flow 136 forming mixture flow 306 as an increased-temperature mixture facilitating reducing icing.

In operation, controller 144 is programmed to open second control valve 134, such that second discharge flow 136 is channeled from compressor assembly 106 through ejector 202 and to intake manifold assembly 114 in response to at least one of the operational limit line control and anti-icing control. Relatively high pressurize second discharge flow 136 generates a suction force at ejector line 204 that draws exhaust flow 304 through ejector line 302 to form mixture flow 306, such that mixture flow 306 is at least the predetermined minimum flow rate required from inlet bleed heat system 300 by intake manifold assembly 114. Furthermore, controller determines whether the operational limit line control and/or anti-icing control are satisfied in response to second discharge flow 136. When second discharge flow is not sufficient to satisfy the operational limit line control and/or anti-icing control, controller 144 is programmed to open first control valve 128, such that first discharge flow 130 is channeled from compressor assembly 106 to intake manifold assembly 114, in response to at least one of the operational limit line control and anti-icing control. In certain embodiments, controller 144 is further programmed to close second control valve 134 during and/or after opening first control valve 128. Alternatively, controller 144 is further programmed to maintain second control valve 134 open during and/or after opening first control valve 128. In the exemplary embodiment, first control valve 128 provides a minimum flow rate for first discharge flow 130 that is at least the predetermined minimum flow rate specified for intake manifold assembly 114 and thus first discharge line 126 does not flow through an ejector. Alternatively or additionally, first discharge line 126 includes an ejector that enables inlet bleed heat system 102 to operate as described herein.

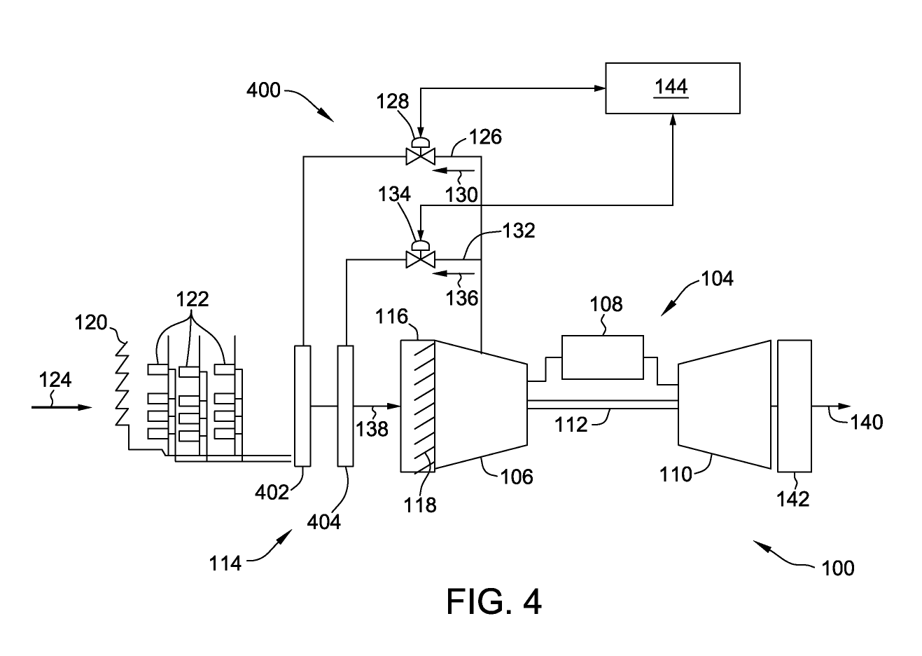

FIG. 4 is a schematic view of turbine assembly 100 including yet another exemplary embodiment of an inlet bleed heat system 400. Inlet bleed heat system 400 is substantially identical to the embodiment described above with respect to FIG. 1, except for as described herein. For example, turbine assembly 100 includes compressor assembly 106, combustor assembly 108, turbine assembly 110, intake manifold assembly 114, and inlet bleed heat system 400. Similarly, inlet bleed heat system 400 includes first discharge line 126, first control valve 128, second discharge line 132, second control valve 134, and controller 144. However, in this embodiment, intake manifold assembly 114 includes a first intake manifold 402 coupled in flow communication with a second intake manifold 404.

In the exemplary embodiment, first intake manifold 402 is coupled to first discharge line 126 and receives first discharge flow 130, while second intake manifold 404 is coupled to second discharge line 132 and receives second discharge flow 136. First intake manifold 402 is sized such that the relatively high minimum flow rate of first discharge flow 130 controlled by first control valve 128 is at least a predetermined minimum flow rate from inlet bleed heat system 102 specified for first intake manifold 402. Additionally, second intake manifold 404 is sized such that the relatively low minimum flow rate of second discharge flow 136 controlled by second control valve 134 is at least a predetermined minimum flow rate from inlet bleed heat system 400 specified for second intake manifold 404. Thus, in the exemplary embodiment, it is not necessary to couple an ejector, such as ejector 202 as described above in reference to FIGS. 2 and 3, to second discharge line 132 in order to satisfy the relatively high predetermined minimum flow rate specified for first intake manifold 402.

In operation, controller 144 is programmed to open second control valve 134, such that second discharge flow 136 is channeled from compressor assembly 106 to second intake manifold 404 of intake manifold assembly 114 in response to at least one of the operational limit line control and anti-icing control. Furthermore, controller 144 determines whether the operational limit line control and/or anti-icing control are satisfied in response to second discharge flow 136. When second discharge flow 136 is not sufficient to satisfy the operational limit line control and/or anti-icing control, controller 144 is programmed to open first control valve 128, such that first discharge flow 130 is channeled from compressor assembly 106 to first intake manifold 402 of intake manifold assembly 114, in response to at least one of the operational limit line control and anti-icing control. In certain embodiments, controller 144 is further programmed to close second control valve 134 during and/or after opening first control valve 128. Alternatively, controller 144 is further programmed to maintain second control valve 134 open during and/or after opening first control valve 128. Alternatively or additionally, at least one of first and second discharge lines 126 and 132 includes an ejector, such as ejector 202 as described above with reference to FIGS. 2 and 3 that enables inlet bleed heat system 400 to operate as described herein.

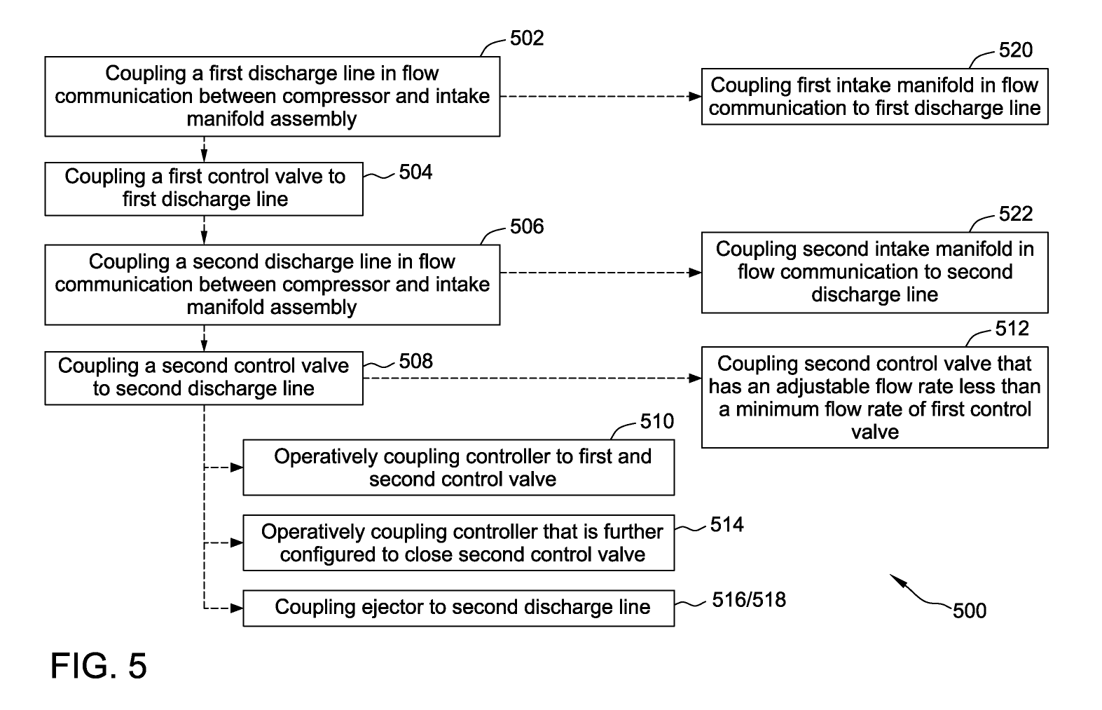

An exemplary method 500 of assembling and inlet bleed heat system, such as systems 102, 200, 300, and 400 as described above in reference to FIGS. 1-4, in turbine assembly 100 is illustrated in the flow diagram of FIG. 5. With reference also to FIGS. 1-4, exemplary method 500 includes coupling 502 a first discharge line, such as first discharge line 126, in flow communication between a compressor, such as compressor assembly 106, and an intake manifold assembly, such as intake manifold assembly 114. Coupling 504 a first control valve, such as first control valve 128, to the first discharge line, the first control valve is operable to control a first discharge flow, such as first discharge flow 130, through the first discharge line from the compressor to the intake manifold assembly during a first operating condition. Coupling 506 a second discharge line, such as second discharge line 132, in flow communication between the compressor and the intake manifold assembly. Coupling 508 a second control valve, such as second control valve 134, to the second discharge line, the second control valve is operable to control a second discharge flow, such as second discharge flow 136, through the second discharge line from the compressor to the intake manifold assembly during a second operating condition.

In certain embodiments, method 500 further includes operatively coupling 510 a controller, such as controller 144, to the first control valve and the second control valve. In the exemplary method 500 the controller opens the second control valve in response from at least one of an operational limit line control and an anti-icing control during the second operating condition, determine whether the second discharge flow is sufficient to satisfy the at least one of the operational limit line control and the anti-icing control, and opens the first control valve in response to determining that the second discharge flow is insufficient to satisfy the at least one of the operational limit line control and the anti-icing control during the first operating condition. In certain embodiments, method 500 includes operatively coupling 514 the controller such that it closes the second control valve during the second operating condition.

In some embodiments, method 500 includes coupling 512 the second control valve that has an adjustable flow rate less than a minimum flow rate of the first control valve. Also, in certain embodiments, method 500 includes coupling 516 an ejector, such as ejector 202, to the second discharge line between the second control valve and the intake manifold assembly such that the ejector receives and mixes the second discharge flow and a turbine exhaust flow, such as exhaust flow 304, to form a first mixture, such as mixture flow 306, and the inlet manifold assembly receives the first mixture. In certain embodiments, method 500 includes coupling 518 the ejector to the second discharge line between the second control valve and the intake manifold assembly such that the ejector receives and mixes the second discharge flow and a filtered ambient air flow, such as filtered ambient air flow 206, to form a first mixture, such as mixture flow 208, and the inlet manifold assembly receives the first mixture.

Furthermore, in some embodiments, the intake manifold assembly includes a first intake manifold, such as first intake manifold 402, and a second intake manifold, such as second intake manifold 404. Method 500 further includes coupling 520 the first intake manifold in flow communication to the first discharge line, and coupling 522 the second intake manifold in flow communication to the second discharge line, wherein the second intake manifold is associated with a predetermined minimum flow rate that is less than a predetermined minimum flow rates associated with the first intake manifold.

Exemplary embodiments of the inlet bleed heat systems and methods are described above in detail. The embodiments described herein provide several advantages in reducing excess compressor bleeding not required for operational limit line control and/or anti-icing control. Specifically, the systems and methods described herein increase control of the required inlet bleed heat flow rate, thereby facilitating reducing turbine output and heat rate losses. The embodiments described herein provide advantages in that first and second discharge lines are in flow communication between a compressor and an inlet bleed heat manifold assembly. Each discharge line includes a control valve that opens in response to at least one of an operational limit line control and an anti-icing control. The second control valve is operated during operational limit line control and/or anti-icing control when the compressor bleed flow rate is below the minimum flow rate through the first control valve, thereby facilitating reducing excess compressor bleeding, turbine output losses, and heat rate losses. Certain embodiments also provide an advantage in that the flow rate of the compressor bleed flow through the second discharge line is increased through use of an ejector that draws in at least one of filtered ambient air and turbine exhaust gas, such that predetermined minimum flow rates required by the inlet bleed heat manifold are satisfied and/or bleed heat temperature is increased. Moreover, some embodiments also provide an advantage in that the compressor bleed flow through the second discharge line is channeled through a second bleed heat manifold sized to match the flow rate of the second valve to provide even flow distribution to the turbine engine. Therefore, the systems and methods described herein enable greater turbine engine efficiency and performance.

The systems and methods described herein are not limited to the specific embodiments described herein. For example, components of each system and/or steps of each method may be used and/or practiced independently and separately from other component and/or steps described herein. In addition, each component and/or step may also be used and/or practiced with other assemblies and methods.

While the disclosure has been described in terms of various specific embodiments, those skilled in the art will recognize that the disclosure can be practiced with modification within the spirit and scope of the claims. Although specific features of various embodiments of the disclosure may be shown in some drawings and not in others, this is for convenience only. Moreover, references to “one embodiment” in the above description are not intended to be interpreted as excluding the existence of additional embodiments that also incorporate the recited features. In accordance with the principles of the disclosure, and feature of a drawing may be referenced and/or claimed in combination with any feature of any other drawing.

What is claimed is:

1. An inlet bleed heat system for use with a turbine assembly, said system comprising:
a first discharge line coupled in flow communication between a compressor and an intake manifold assembly;
a first control valve coupled to said first discharge line and operable to control a first discharge flow through said first discharge line from the compressor to the intake manifold assembly during a first operational mode;
a second discharge line coupled in flow communication between the compressor and the intake manifold assembly; and
a second control valve coupled to said second discharge line and operable to control a second discharge flow through said second discharge line from the compressor to the intake manifold assembly during a second operational mode.

2. The system in accordance with claim 1 further comprising a controller operatively coupled to said first and second control valves, said controller configured to:
open said second control valve in response to at least one of an operational limit line control and an anti-icing control during the second operational mode;
determine whether the second discharge flow is sufficient to satisfy the at least one of the operational limit line control and the anti-icing control; and
open said first control valve in response to determining that the second discharge flow is insufficient to satisfy the at least one of the operational limit line control and the anti-icing control during the first operational mode.

3. The system in accordance with claim 2, wherein said controller is configured to close said second control valve during the second operational mode.

4. The system in accordance with claim 1, wherein an adjustable flow rate of said second control valve is less than a minimum flow rate of said first control valve.

5. The system in accordance with claim 1 further comprising an ejector coupled to said second discharge line between said second control valve and the intake manifold assembly, said ejector configured to mix the second discharge flow and a turbine exhaust flow to form a first mixture, wherein the inlet manifold assembly is configured to receive the first mixture.

6. The system in accordance with claim 1 further comprising an ejector coupled to said second discharge line between said second control valve and the intake manifold assembly, said ejector configured to mix the second discharge flow and a filtered ambient air flow to form a first mixture, wherein the inlet manifold assembly is configured to receive the first mixture.

7. The system in accordance with claim 1, wherein the intake manifold assembly comprises a first intake manifold and a second intake manifold, the first intake manifold coupled in flow communication to said first discharge line, and the second intake manifold coupled in flow communication to said second discharge line.

8. The system in accordance with claim 7, wherein the second intake manifold is associated with a predetermined minimum flow rate that is less than a predetermined minimum flow rate associated with the first intake manifold.

9. A turbine engine assembly comprising:
an intake manifold assembly;
a compressor coupled in flow communication and downstream from said intake manifold assembly;
a turbine coupled in flow communication and downstream from said compressor; and
an inlet bleed heat system comprising:
a first discharge line coupled in flow communication between said compressor and said intake manifold assembly;
a first control valve coupled to said first discharge line and operable to control a first discharge flow through said first discharge line from said compressor to said intake manifold assembly during a first operating condition;
a second discharge line coupled in flow communication between said compressor and said intake manifold assembly; and
a second control valve coupled to said second discharge line and operable to control a second discharge flow through said second discharge line from said compressor to said intake manifold assembly during a second operating condition.

10. The turbine engine assembly in accordance with claim 9 further comprising a controller operatively coupled to said first and second control valves, said controller configured to:
open said second control valve in response to at least one of an operational limit line control and an anti-icing control during the second operating condition;
determine whether the second discharge flow is sufficient to satisfy the at least one of the operational limit line control and the anti-icing control; and
open said first control valve in response to determining that the second discharge flow is insufficient to satisfy the at least one of the operational limit line control and the anti-icing control during the first operating condition.

11. The turbine engine assembly in accordance with claim 9, wherein an adjustable flow rate of said second control valve is less than a minimum flow rate of said first control valve.

12. The turbine engine assembly in accordance with claim 9, wherein said controller is configured to close said second control valve at least one of during and after opening said first control valve.

13. The turbine engine assembly in accordance with claim 9 further comprising an ejector coupled to said second discharge line between said second control valve and said intake manifold assembly, said ejector configured to mix the second discharge flow and a turbine exhaust flow to form a first mixture, wherein said inlet manifold assembly is configured to receive the first mixture.

14. The turbine engine assembly in accordance with claim 9 further comprising an ejector coupled to said second discharge line between said second control valve and said intake manifold assembly, said ejector configured to mix the second discharge flow and a filtered ambient air flow to form a first mixture, wherein said inlet manifold assembly is configured to receive the first mixture.

15. The turbine engine assembly in accordance with claim 8, wherein said intake manifold assembly comprises a first intake manifold and a second intake manifold, said first intake manifold coupled in flow communication to said first discharge line, said second intake manifold coupled in flow communication to said second discharge line, and wherein said second intake manifold is associated with a predetermined minimum flow rate that is less than a predetermined minimum flow rate associated with said first intake manifold.

16. A method of assembling an inlet bleed heat system in a turbine assembly, said method comprising:
coupling a first discharge line in flow communication between a compressor of the turbine assembly and an intake manifold assembly;
coupling a first control valve to the first discharge line, the first control valve operable to control a first discharge flow through the first discharge line from the compressor to the intake manifold assembly during a first operating condition,
coupling a second discharge line in flow communication between the compressor and the intake manifold assembly;
coupling a second control valve to the second discharge line, the second control valve operable to control a second discharge flow through the second discharge line from the compressor to the intake manifold assembly during a second operating condition.

17. The method in accordance with claim 16 further comprising operatively coupling a controller to the first control valve and the second control valve, the controller configured to:
open the second control valve in response to at least one of an operational limit line control and an anti-icing control during the second operating condition;
determine whether the second discharge flow is sufficient to satisfy the at least one of the operational limit line control and the anti-icing control; and
open the first control valve in response to determining that the second discharge flow is insufficient to satisfy the at least one of the operational limit line control and the anti-icing control during the first operating condition.

18. The method in accordance with claim 16 further comprising coupling an ejector to the second discharge line between the second control valve and the intake manifold assembly, wherein the ejector is configured to mix the second discharge flow and a turbine exhaust flow to form a first mixture, and wherein the inlet manifold assembly is configured to receive the first mixture.

19. The method in accordance with claim 16 further comprising coupling an ejector to the second discharge line between the second control valve and the intake manifold assembly, wherein the ejector is configured to mix the second discharge flow and a filtered ambient air flow to form a first mixture, and wherein the inlet manifold assembly is configured to receive the first mixture.

20. The method in accordance with claim 16, wherein the intake manifold assembly includes a first intake manifold and a second intake manifold, said coupling the first discharge line further comprises coupling the first intake manifold in flow communication to the first discharge line, and said coupling the second discharge line further comprises coupling the second intake manifold in flow communication to the second discharge line, wherein the second intake manifold is associated with a predetermined minimum flow rate that is less than a predetermined minimum flow rate associated with the first intake manifold.
